(19) United States
(12) Patent Application Publication
(10) Pub. No.: US 2006/0031522 A1
(43) Pub. Date: Feb. 9, 2006

(54) Method and network entity for session initiation protocol (SIP) based network traffic measurements

(75) Inventors: Said Soulhi, Saint Constant (CA); Stephane Desrochers, Blainville (CA)

Correspondence Address: Sandra Beauchesne;Ericsson Canada Inc., Patent Department, 8400 Decarie Blvd., Town Mount Royal, QC, H4P 2N2, CA

(73) Assignee: Telefonaktiebolaget L M Ericsson (publ)

(21) Appl. No.: 10/857,003

(22) Filed: Jun. 1, 2004

(51) Int. Cl. G06F 15/16

(52) U.S. Cl. 709/227

(57) ABSTRACT

A method, network entity and test controller for establishing a Session Initiation Protocol (SIP) session between a plurality of SIP-based network entities and performing test measurements over the SIP session. The test controller instructs the network entities to establish the SIP session and specifies which test measurements are to be performed. The SIP session is established between the network entities, the test measurements are carried out, and the results are reported back to the test controller by at least one of the network entities, which may be terminals or packet data nodes such as a CDMA2000 Packet data Switched Node (PDSN) or Base Station Controller (BSC). The network entities may comprise SIP user agents and test modules in the forms of software and/or hardware.

### BACKGROUND OF THE INVENTION

1. Field of the Invention

The present invention relates to network traffic measurements.

2. Description of the Related Art

Network traffic measurements constitute an important activity field of performance management. Many useful measurements can be carried out, for example, on 3rd Generation (3G) telecommunications networks, as well as in other data networks, for insuring their proper configuration (e.g. proper dimensioning of routing parameters) and optimal usage of network resources. Traffic measurements are also employed for dimensioning multimedia applications and services executed in the host environment of telecommunications nodes of such networks.

Traffic measurements are also used for asserting the Quality of Service (QoS) provided to the operator's end-users. Measuring the network QoS from the user's perspective is also a measure of the degree of satisfaction of these users.

Thus, at the present time, the use of active measurement systems is a vital feedback mechanism for performance management in a data network. Many metrics were recently defined and standardized for the sake of performing traffic measurements in IP (Internet Protocol) based networks. These metrics can also be used in the context of 3G networks as well as in all IP wireless networks, and include the following Requests For Comments (RFCs) published by the Internet Engineering Task Force (IETF):
Connectivity—RFC2678;
One Way Delay—RFC2679;
One-Way Packet Loss—RFC2680;
IP Packet Delay Variation—RFC3393;
Round-trip Delay—RFC2681;
Empirical Bulk Transfer Capacity—RFC3148;
One-way Loss Pattern Sample—RFC 3357 and
Periodic streams—RFC 3432; all of which are herein included by reference in their entirety.

Currently, test and measuring methods can be categorized in two classes: (a) passive measurements methods and (b) active measurements methods. Passive measurements methods involve probes that sniffs, or record, the network data traffic in particular areas or points, and that compute statistics from the taken connection samples. Passive measurements can only offers an indirect measure of user satisfaction and rarely provide a reliable picture of the network's perceived QoS; many types of quality degradations that a network user might experience cannot be detected by passive measurements. On the other side, active measurements aims at injecting new test data packets in the network and measure parameters relative to those data packets. The test data packets introduced in the network can also interact with a service to measure its responsiveness. Active measurements provide a better and more realistic picture of the network's perceived QoS than passive measurements, but are expensive to deploy and difficult to manage. Also, test stations used for the active measurements are generally not mobile and are not necessarily placed in user representative regions of the network.

In current implementations of the above-mentioned metrics, measurements are triggered and handled manually, or using burdensome solutions that involve costly operation of dedicated test stations. For example, if an active traffic measurement is to be performed in a Code Division Multiple Access 2000 (CDMA2000) cellular network for measuring traffic latency between a first terminal residing in a first radio cell of the network and a second terminal residing in a second radio cell of the network, network administrators must first deploy the first testing terminal in the first radio cell and the second testing terminal in the second radio cell. Thereafter, they must initiate data traffic between the first and second testing terminals, and record the data latency of the established data communication. However, this scenario, which involves at least two teams of skilled network administrators and the use of dedicated testing terminals for recording traffic measurements, constitutes a costly solution for network operators.

It was also further noticed that even the active deployment of dedicated testing terminals for recording traffic measurements in arbitrary spots of an existing commercial network does not always reflect actual user experience, and therefore the use of such testing terminals may not actually representative of the real data traffic status of the tested data network. The same problem arises for passive measurements (i.e.: sniffing network traffic), these are only indirect measurement of user's experiences with the network and its services.

Although there is no prior art solution as the one proposed hereinafter for solving the above-mentioned deficiencies, the US patent application publication US 2003/0033118 bears some relation with the field of the present invention. In the patent application publication US 2003/0033118, there is disclosed a system for benchmarking data transfers using different transport mechanisms between processes run on various nodes of a network, wherein a Central Manager Component interfaces with the user and reports benchmark results. An Agent Component under the control of the manager component is also provided on each of the nodes. The Agent Component conducts benchmarking tests under the direct instruction of the manager component and reports the results to the Manager Component. However, the present publication is silent on the use of SIP protocol and SIP user agents for performing traffic measurements during a data communication in a data network, as it is further silent on reporting measurements results related to such a data communication to a traffic controller, as in the present invention.

Accordingly, it should be readily appreciated that it would be advantageous to have a method and system for making an effective use of the flexibility of SIP for performing traffic measurements in a data network without the need of using dedicated testing terminals and manual handling of the test sessions. The present invention provides such a method and system.

### SUMMARY OF THE INVENTION

In one aspect, the present invention is a method for test measurements in a data network, the method comprising the steps of:

a. instructing by a test controller an establishment of a Session Initiation Protocol (SIP) session between a plurality of network entities;

b. establishing the SIP session between the plurality of network entity; and

c. performing test measurements over the SIP session by at least one of the plurality of network entity.

In another aspect, the invention is a first network entity for test measurements in a data network, the first network entity comprising:

a Session Initiation Protocol (SIP) user agent for establishing a SIP session with a second network entity; and

a test module for performing test measurements over the SIP session established with the second network entity;

wherein the first network entity receives an instruction for establishing the SIP session with the second network entity from a test controller, and responsive to the instruction, the SIP user agent establishes the SIP session and the test module performs test measurements over the SIP session.

In yet another aspect, the invention is a test controller comprising:

a Session Initiation Protocol (SIP) user agent acting to send SIP messages for instructing a first and a second SIP-based network entities to establish a SIP session there between and to carry out test measurements;

wherein the test controller receives back from at least one of the first and second network entities results of the test measurements once the test measurements are carried on over the SIP session.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary high-level network diagram illustrative of a data network implementing the preferred embodiment of the present invention; and

FIG. 2 is an exemplary nodal operation and signal flow diagram of a data network implementing the preferred embodiment of the present invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention solves the problem of obtaining credible Quality of Service (Qos) measurements in today's increasingly complex data networks in a cost-efficient, scalable, and automated manner. The invention proposes a new methodology for setting up measurement sessions between existing network entities, such as for example wireless or wireline terminals and data traffic nodes of the tested packet switched network. The invention further allows for the control of the established measurement sessions and the fetching of the results of the measurement sessions.

The present inventions makes use of the Session Initiation Protocol (SIP) for setting up and controlling measurement sessions between two or more network entities, where test sessions parameters and instructions are exchanged using, for example, the Session Description Protocol (SDP). SIP is defined in RFC 2543, which is herein included by reference in its entirety, and allows initiating, modifying and terminating network sessions. SDP is defined in RFC 2327, which is also herein included by reference in its entirety, and allows for the description of the sessions using a general-purpose textual format. Thus, the invention defines an extension of SIP to be used to set up and control measurement sessions between two or more network entities. The advantages of using SIP for carrying out test session management include the wide availability of SIP, its flexibility for applications having the notion of session, the reuse of the same technology used in 3G (3rd Generation) networks and IP world, and the native support of the SIP for session management with session control, addressing, and security. Finally, SIP can also support the establishment of complex test scenarios, such as for example multiparty testing architectures.

Thus, because the present invention uses SIP for setting up traffic measurement sessions, the invention may be suitable for various testing applications that make use of the notion of data session, including for testing all IP and 3G networks. SIP comprises support for session management with session control, addressing, security, and thus enables complex test scenarios, such as for example multiparty testing architectures.

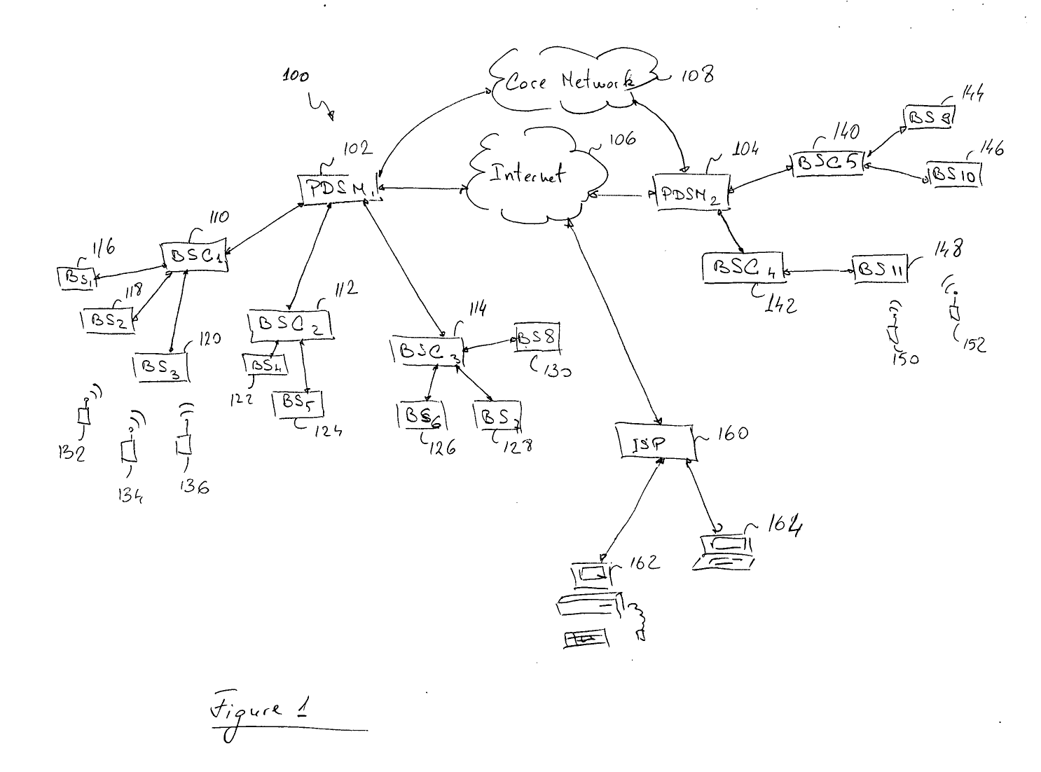

Reference is now made to FIG. 1, which is an exemplary high-level network diagram illustrative of a network 100 implementing the preferred embodiment of the present invention. Shown in FIG. 1 is the exemplary network 100, which may be, for example, a CDMA2000 cellular network comprising a first and a second Packet Data Service Nodes PDSN1 102 and PDSN2 104, which may be connected to each other via the Internet 106, or alternatively via a core network 108 (note that the core network 108 may also comprise the PDSNs 102 and 104). In FIG. 1, PDSN1 102 is linked to three (3) Base Station Controllers BSC1 110, BSC2 112, and BSC3 114, which control wireless communications of their respective sets of Base Stations (BSs) 116-120, 122-124, and 126-130. Also shown for illustrative purposes are three (3) Mobile Stations (MSs) 132-136 capable of establishing wireless communications at least with BS3 120 over an air interface (not shown). Likewise, PDSN2 104 is also connected to two (2) BSCs 140 and 142, which are in turn connected to their respective sets of BSs 144-146 and 148, as shown. Also represented in FIG. 1 for illustrative purposes, are mobile stations 150-152 capable of establishing wireless communications at least with the BS11 148. Finally, an Internet Service Provider (ISP) 160 can also be connected to the Internet 106 for providing Internet connection to two (2) Personal Computer (PC) terminals 162 and 164.

With reference being further made to FIG. 1, instances arise when the network operator of the exemplary network 100 may desire to perform data traffic measurements within a specific area of the network 100, in order to gauge the quality of data communications provided by that specific area of the network. For this purpose, according to the present invention, the network administrator may instruct one or more network entities of the network 100, such as for example certain ones of the terminal network entities MSs 132-136 and 150-152 to establish data communications therebetween, and perform testing session according to a testing instruction provided by the administrator. Alternatively, the network operator may instruct another type of network entities, such as for example traffic nodes (also referred herein as packet data switched nodes) PDSN1 102 and PDSN2 104 to establish a data session and perform the required traffic measurements. It is understood that according to the present invention such testing data sessions and traffic measurements may be established between any type of network entities of the network, such as for example between two or more packet data nodes such as the BS2 118 and the PDSN2 104, on instruction of a test controller station, such as for example of the terminal 164, which may be responsible for providing the user identities of the test parties, as well as a list of one or more measurements or tests to be performed. Alternatively, test sessions may also be performed between a network entity and an Internet server.

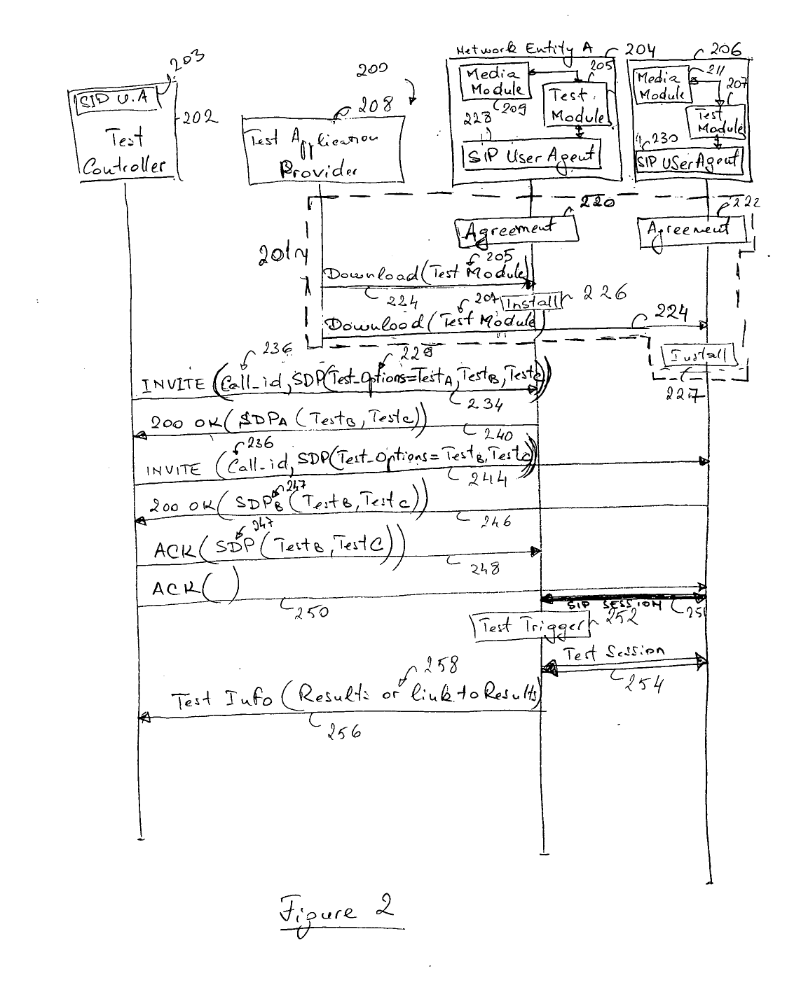

Reference is now made to FIG. 2, which is an exemplary nodal operation and signal flow diagram of the network 200 implementing the preferred embodiment of the present invention, wherein test sessions are established between data nodes of the network 200 on instruction of a test controller station 202 using SIP. Also shown in FIG. 2 are a first and a second Network Entities A 204 and B 206, which are to carry out the test session including the data measurements, a Test Application Provider 208 that in a variant of the preferred embodiment of the invention may be responsible for providing to the network entities test data program(s) 205 and 207 for carrying on the test session, and a Test Controller 202 having a SIP User Agent capable of establishing, controlling and tearing down SIP session, including SIP session between third-parties. The Network Entities A 204 and B 206 may be any kind of entities of a data network, such as for example but not limited to a fixed or a wireless terminals, e.g. a fixed IP-based Internet terminal or a CDMA2000 wireless terminal, or further a node of a telecommunications network, such as for example a BSC or a PDSN of a CDMA2000 network.

In order to be able to establish SIP sessions and carry out tests and measurements over the SIP session, Network Entities A 204 and B 206 may comprise respective SIP User Agents 228 and 230, which may consist of appropriate software and/or hardware modules capable of establishing, controlling, and tearing down the SIP sessions on behalf of its respective entity

The Entities 204 and 206 may further comprise respective Test Modules 205 and 207 which function is to carry out test measurements once the SIP session is established. The Test Modules 205 and 207 may comprise software modules, hardware modules, or a combination thereof. In a first variant of the invention, the Test Modules may be original parts of the Network Entities 204 and 206 and may comprise hardware pre-installed in the network entities A 204 and B 206, or a combination of pre-installed hardware and software modules, while in a second variant yet to be described, the Test Modules may be software modules or pluggins downloadable from a web-based server. For example, in cases wherein the entities 204 and 206 are data terminals, it may be preferable having the Test Modules implemented as software modules that may be downloaded from a central repository such as the Test Application Provider 208, while if the entities 204 and 206 are packet data nodes of the data network, such as for example a PDSN of a CDMA200 network, the Test Modules may be preferably implemented using hardware only, or both hardware and software service logic.

Finally, the Entities 204 and 206 may further comprise one or more Media Module 209 and 211, such as for example an audio and/or video streaming module, responsible of carrying out various types of media on behalf of the corresponding Entity.

With reference being made to FIG. 2, according to an optional second variant 201 of the invention, the network entities A 204 and B 206 first accept, actions 220 and 222, to act as test entities. For example, the network entities A 204 and B 206 may be wireless or wireline terminals of the data network 200 (e.g. a CDMA2000 cellular network) and the authorization of the subscribers of the terminals may be required for performing data measurements using these terminals. Upon authorization, the Test Modules 205 and 207 may be downloaded, actions 224, from the web-based Test Application provider 208 into the Entities 204 and 206, where it is installed, actions 226 and 227. The Test Modules 205 and 207 may comprise a program, script, or pluggin responsible for performing tests and measurements for an ongoing data session.

With reference being made further to FIG. 2, following actions 226 and 227 both Entities A 204 and B 206 are equipped with Test Modules 205 and 207 respectively for carrying out data measurements.

It is to be noted that other variants may exist, as mentioned, wherein the action 201 need not to be performed since Modules 205 are pre-installed in Network Entities 204 and 206.

In action 234, the Test Controller 202, via its SIP User Agent 203, invites the Network Entity A 204 to participate to a test session, by sending a SIP INVITE message comprising a call identification 236 identifying the test session and SDP (Session Description Protocol) parameters including test options 229 requested from the Test Module 205. In the present exemplary scenario, the test options 229 comprise instructions to execute test measurements identified by A, B, and C. Typically, such test options comprise the identity of the tests to be executed, or the test scripts/programs themselves, and possibly additional parameters to perform the tests.

The SIP INVITE message 234 may also include the test options 229 apart from the SDP parameters normally associated with the establishment of a new SIP session, and may even not comprise SDP parameters at all, which may indicate to the SIP User Agent 228 to expect SDP information in a subsequent SIP ACK message. In action 240, the Network Entity A 204, via its SIP User Agent 228, replies back to the test application provider with a SIP 200 OK message specifying the test options it supports, which in the present case are test measurements B and C. Additionally, it may further include initial SDP information in the payload of the message for the establishment of the test sessions. The test controller 202 then sends a similar SIP INVITE message 244 to request Network Entity B 206 to participate in the test session, the message containing the same call identification 236 and the desired test options B and C, which were accepted by Entity A 204. Network entity B 206 also responds with a SIP 200 OK message 246 containing its SDP information 247 in the payload, confirming it accepts and supports test measurements B and C. Then, the test controller 202 sends a SIP ACK message 248 to Network Entity A with the SDP information 247 obtained from network entity B, i.e. the test measurements B and C. Finally, the test controller 202 sends a SIP ACK message 250 to network entity B with no SDP.

Since each one of the entities A 204 and B 206 have received the SIP INVITE messages 234 and 244 respectively and accepted a common set of test measurements (tests B and C), the SIP session 251 is now established between the two entities. Both Network Entities A 204 and B 206 are informed, and have accepted, to carry out test measurements B and C over the SIP session.

The test measurements B and C may start immediately upon establishment of the SIP session 251, or alternatively may be triggered by a test trigger, action 252, such as for example a timer, the occurrence of a given condition, or an explicit or implicit instruction to start the tests once the SIP session is established.

Test measurements B and C are started and carried out over the SIP data session, action 254, by the Network Entities A 204 and B 206. During such tests, data packets may be exchanged between the Entities 204 and 206 and various parameters of the exchange, such as for example the latency of the communication, the available bandwidth, the errors of the communication, etc, may be recorded by at least one of the Entities. For example, the Test Modules 205 and 207 may instruct the Media Modules 209 and 211 to exchange a given type of data packets, such as for example video data packets and perform the measurements on these packets.

When the test measurements are completed, at least one of the participating network entities A 204 and B 206 sends a SIP INFO message 256 to the test controller 208, wherein the payload of the message 256 contains the results 258 of the test measurements B and C, or alternatively a link or connection information to the location where the test results are stored (e.g. http link).

At this point, the Test Controller 202 may end the session using SIP BYE messages 260, or alternatively order another test using another SIP INVITE message (not shown).

Based upon the foregoing, it should now be apparent to those of ordinary skills in the art that the present invention provides an advantageous solution, which offers automated and scalable active test measurement method. Although the system and method of the present invention have been described in particular reference to certain radio telecommunications messaging standards (for example CDMA2000), it should be realized upon reference hereto that the innovative teachings contained herein are not limited there to and may be implemented advantageously with any applicable radio telecommunications standard applicable to any fixed or mobile data communications network, such as for example but not limited to GSM, any CDMA-based networks, UMTS, fixed IP-based telephony, etc. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for test measurements in a data network, the method comprising the steps of:
a. instructing by a test controller an establishment of a Session Initiation Protocol (SIP) session between a plurality of network entities;
b. responsive to the instruction of the test controller, establishing the SIP session between the plurality of network entity; and
c. performing test measurements over the SIP session by at least one of the plurality of network entity.

2. The method claimed in claim 1, further comprising the step of:
d. reporting results of the test measurements to the test controller.

3. The method claimed in claim 1, wherein the plurality of network entities comprises a first network entity and a second network entity, and wherein step b. comprises establishing the SIP session between the first and the second network entity.

4. The method claimed in claim 1, wherein step a. comprises the step of:
a.1. sending a first SIP INVITE message from the test controller to a first network entity from the plurality of network entities for requesting the establishment of the SIP session; and
a.2. sending a second SIP INVITE message from the test controller to a second network entity from the plurality of network entities for requesting the establishment of the SIP session;
wherein the first and second SIP NVITE messages comprises test options for performing the test measurements over the SIP session.

5. The method claimed in claim 1, further comprising the steps of:
d. downloading a first test module from a test application provider by a first network entity from the plurality of network entities;
e. installing the first test module in the first network entity;
f. downloading a second test module from the test application provider by a second network entity from the plurality of network entities; and
g. installing the second test module in the second network entity.

6. The method claimed in claim 1, wherein at least one of the plurality of network entities is a network terminal.

7. The method claimed in claim 1, wherein at least one of the plurality of network entities is a packet data node.

8. A first network entity for test measurements in a data network, the first network entity comprising:
a Session Initiation Protocol (SIP) user agent for establishing a SIP session with a second network entity; and
a test module for performing test measurements over the SIP session established with the second network entity;
wherein the first network entity receives an instruction for establishing the SIP session with the second network entity from a test controller, and responsive to the instruction, the SIP user agent establishes the SIP session and the test module performs test measurements over the SIP session.

9. The first network entity claimed in claim 8, wherein the SIP user agent further reports results of the test measurements to the test controller.

10. The first network entity claimed in claim 8, the first network entity receives a SIP INVITE message from the test controller for requesting the establishment of the SIP session, the SIP NVITE message comprising test options for performing the test measurements over the SIP session.

11. The first network entity claimed in claim 1, wherein the test module is downloaded from a test application provider, and is installed in the first network entity.

12. The first network entity claimed in claim 1, wherein the network entity is a network terminal.

13. The first network entity claimed in claim 1, wherein the network entity is a packet data switched node.

14. A test controller comprising:
a Session Initiation Protocol (SIP) user agent acting to send SIP messages for instructing a first and a second SIP-based network entities to establish a SIP session there between and to carry out test measurements;
wherein the test controller receives back from at least one of the first and second network entities results of the test measurements once the test measurements are carried on over the SIP session.

15. The test controller claimed in claim 14, wherein the test controller specifies which test measurements are to be carried out by the first and second network entities.
